(19) United States
(12) Patent Application Publication
(10) Pub. No.: US 2013/0282804 A1
(43) Pub. Date: Oct. 24, 2013

(54) METHODS AND APPARATUS FOR MULTI-DEVICE TIME ALIGNMENT AND INSERTION OF MEDIA

(71) Applicants: Sujeet Shyamsundar Mate, Tampere (FI); Curcio Igor, Tampere (FI)

(72) Inventors: Sujeet Shyamsundar Mate, Tampere (FI); Curcio Igor, Tampere (FI)

(73) Assignee: NOKIA, INC., Espoo (FI)

(21) Appl. No.: 13/450,967

(22) Filed: Apr. 19, 2012

(51) Int. Cl. G06F 15/16

(52) U.S. Cl. 709/204

(57) ABSTRACT

An apparatus comprising at least one processor and at least one memory including computer program code, the at least one memory, computer program code, and processor configured to cause the apparatus to receive at least a first media content from a first device configured to capture media content and a second media content from a second device configured to capture media content. The apparatus may be configured to align the continuous media content from the first media content to the continuous media content from the second media content. The apparatus may be configured to measure the time intervals between the non-continuous media content and the continuous media content. The apparatus may be configured to align the non-continuous media content with respect to the continuous media content, based at least in part by the measured time intervals. Corresponding methods and computer program products are also provided.

### TECHNOLOGICAL FIELD

An example embodiment of the present invention relates generally to techniques for the temporal alignment of media captured by varying devices, and more particularly, relates to an apparatus, a method and a computer program product for aligning media captured by different devices along a singular unified timeline.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Further, mobile terminals now include capabilities to capture media content, such as photographs and/or video recordings. As such, users may now have the ability to record media whenever users have access to an appropriately configured mobile terminal. When multiple users attend an event with each user using a different mobile terminal to capture various media content in light of the event activities, the captured media content may include redundant or overlapping content. The overlap may, for example, be exploited in the time domain. Further, some users may capture content of particular portions of the event and not capture other portions of the event. Accordingly, the total amount of content captured by multiple users at a particular event may include time intervals where no content was captured. Thereby, the entire library of captured content by the multiple users may be compiled together to provide a single timeline view of the content captured at a particular event.

Currently, problems may arise when the multiple users attempt to align media content, such as pictures, taken by different devices at a particular event. Each mobile device may have different internal clocks that are not aligned. Accordingly, any one timestamp from any particular mobile device may not coincide with a timeline established by another device. Further, another user may use a device that is configured to display a different time zone than the current time zone of the user. As such, any media content captured by the particular device would include timestamps relative to the different time zone and not the current time zone.

### BRIEF SUMMARY

A method, apparatus and computer program product therefore provide for aligning media content captured of an event by different devices. For example, methods, apparatuses and computer program products of one example embodiment may provide for the alignment of continuous media content, such as video and/or audio data, and the alignment of non-continuous media content, such as picture or image data and/or the like.

In a first example embodiment, an apparatus comprising at least one processor and at least one memory including computer program code, the at least one memory and the computer program code configured to, with the processor, may cause the apparatus to receive at least a first media content from a first device configured to capture media content. In addition, an apparatus comprising at least one processor and at least one memory including computer program code, the at least one memory and the computer program code configured to, with the processor, may cause the apparatus to receive at least a second media content from a second device configured to capture media content, wherein the first and second media content each comprise at least one continuous media content, and wherein at least one of the media content comprises a non-continuous media content. Further still, an apparatus comprising at least one processor and at least one memory including computer program code, the at least one memory and the computer program code configured to, with the processor, may cause the apparatus to align the continuous media content from the first media content to the continuous media content from the second media content. In another embodiment, an apparatus comprising at least one processor and at least one memory including computer program code, the at least one memory and the computer program code configured to, with the processor, may cause the apparatus to measure the time intervals between the non-continuous media content and the continuous media content for any media content captured by a device, wherein the media content comprises non-continuous media content and continuous media content. According to one embodiment, an apparatus comprising at least one processor and at least one memory including computer program code, the at least one memory and the computer program code configured to, with the processor, may cause the apparatus to align the non-continuous media content with respect to media content captured by another device, based at least in part by the measured time intervals.

In another example embodiment, a method may include receiving at least a first media content from a first device configured to capture media content. Further, method may include receiving at least a second media content from a second device configured to capture media content, wherein the first and second media content each comprise at least one continuous media content, and wherein at least one of the media content comprises a non-continuous media content. Additionally, a method may include aligning, by a processor, the continuous media content from the first media content to the continuous media content from the second media content. Further, the method may include measuring the time intervals between the non-continuous media content and the continuous media content for any media content captured by a device, wherein the media content comprises non-continuous media content and continuous media content. According to another embodiment, the method may include aligning the non-continuous media content with respect to media content captured by another device, based at least in part by the measured time intervals.

In another example embodiment, a computer program product is provided. The computer program product of the example embodiment may include at least one non-transitory computer-readable storage medium having computer-readable program instructions stored therein. The computer-readable program instructions may comprise program instructions configured to cause an apparatus to perform a method comprising receiving at least a first media content from a first device configured to capture media content. Further, the method may include receiving at least a second media content from a second device configured to capture media content, wherein the first and second media content each comprise at least one continuous media content, and wherein at least one of the media content comprises a non-continuous media content. In addition, the method may include aligning the continuous media content from the first media content to the continuous media content from the second media content. According to one embodiment, the method may include measuring the time intervals between the non-continuous media content and the continuous media content for any media content captured by a device, wherein the media content comprises non-continuous media content and continuous media content. Additionally, the method may include aligning the non-continuous media content with respect to the media content captured by another device, based at least in part by the measured time intervals.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of a mobile terminal according to an example embodiment of the present invention;

FIG. 3 illustrates a schematic block diagram of an apparatus configured to align a plurality of media content according to an example embodiment of the present invention;

FIG. 4a illustrates a timeline for a first device configured to capture media content according to one example embodiment of the present invention;

FIG. 4b illustrates a timeline for a second device configured to capture media content according to one example embodiment of the present invention;

FIG. 4c illustrates a timeline for a third device configured to capture media content according to one example embodiment of the present invention;

FIG. 5 illustrates a combined timeline for multiple devices configured to capture media content according to one example embodiment of the present invention;

FIG. 6 illustrates another combined timeline for multiple devices configured to capture media content according to one example embodiment of the present invention;

FIG. 7 illustrates yet another combined timeline for multiple devices configured to capture media content according to another example embodiment of the present invention; and

FIG. 8 illustrates a flowchart detailing a method according to one example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

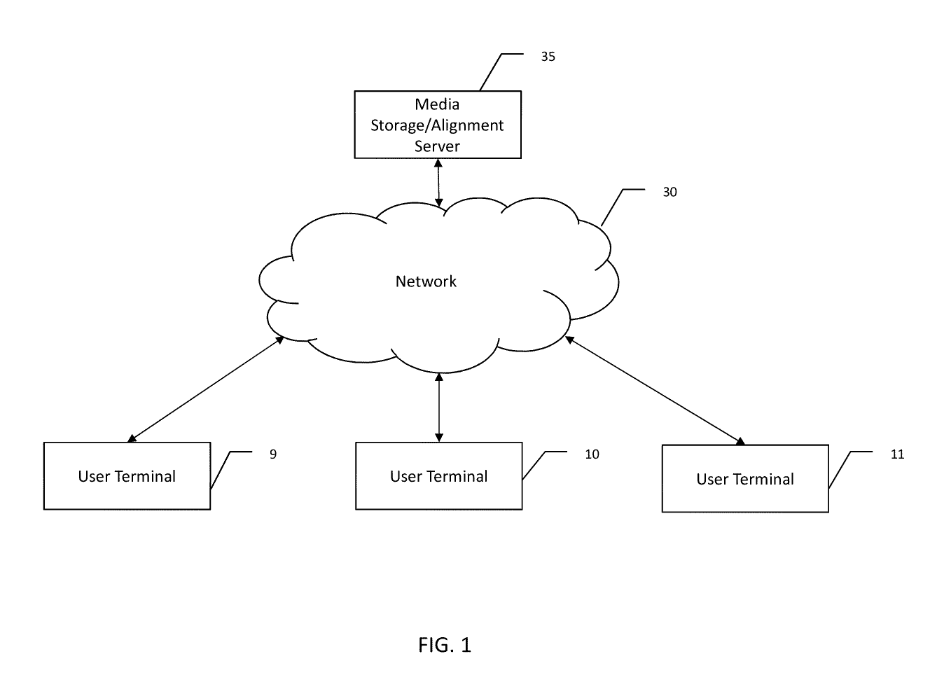

As indicated above, some embodiments of the present invention may be employed in methods, apparatuses and computer program products configured to provide dynamic content segments based at least in part on a user preference model and/or user interactions with a content package. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a plurality of user terminals 9, 10, 11. A user terminal 10 may be any of multiple types of fixed or mobile communication and/or computing devices such as, for example, personal digital assistants (PDAs), pagers, mobile televisions, mobile telephones, gaming devices, laptop computers, tablet computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, such as other user terminals, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as universal mobile telecommunications system (UMTS), wideband code division multiple access (W-CDMA), CDMA2000, time division-synchronous CDMA (TD-CDMA), global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to capture media content, such as pictures and/or video. As such, the system may additionally comprise at least one media storage and alignment server 35 which may be configured to receive content from any one of the user terminals 9, 10, 11, either directly or via the network 30. In some embodiments, the media storage and alignment server 35 may be embodied as a single server, server bank, or other computer or other computing devices or node configured to align media content received by any number of user terminals. As such, for example, the media storage and alignment server may include other functions or associations with other services such that media content stored on the media storage and alignment server may be provided to other devices, other than the user terminals which originally captured the media content. Thus, the media storage and alignment server may provide public access to temporally aligned media content received from a number of user terminals. In other embodiments, the media storage and alignment server may be configured to provide private access to the temporally aligned media content, such that only those users having the required authority may access the temporally aligned media content.

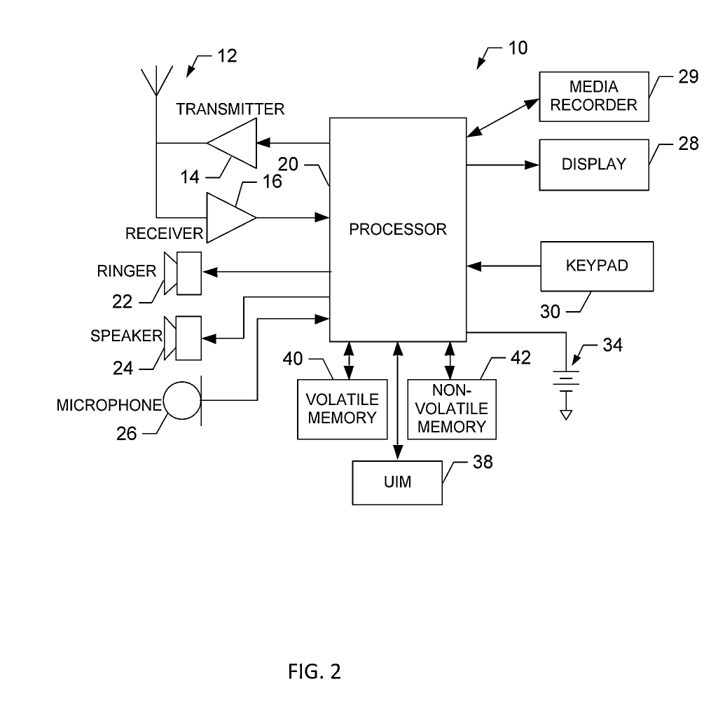

FIG. 2 illustrates a block diagram of a mobile user terminal 10 that would benefit from embodiments of the present invention. Indeed, the mobile user terminal 10 may serve as the user terminal in the embodiment of FIG. 1 so as to capture media content and transmit such content to a media storage and alignment server. It should be understood, however, that the mobile user terminal 10 as illustrated and hereinafter described is merely illustrative of one type of device that may serve as the user terminal and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

As shown, the mobile user terminal 10 may include an antenna 12 (or multiple antennas 12) in communication with a transmitter 14 and a receiver 16. The mobile user terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local area network (WLAN) techniques such as Institute of Electrical and Electronics Engineers (IEEE) 802.11, 802.16, and/or the like. In addition, these signals may include media content data, user generated data, user requested data, and/or the like. In this regard, the mobile user terminal may be capable of operating with one or more air interface standards, communication protocols, modulation types, access types, and/or the like. Some Narrow-band Advanced Mobile Phone System (NAMPS), as well as Total Access Communication System (TACS), mobile user terminals may also benefit from embodiments of this invention, as should dual or higher mode phones (e.g., digital/analog or TDMA/CDMA/analog phones). Additionally, the mobile user terminal 10 may be capable of operating according to Wi-Fi or Worldwide Interoperability for Microwave Access (WiMAX) protocols.

It is understood that the processor 20 may comprise circuitry for implementing audio/video and logic functions of the mobile user terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the mobile user terminal 10 to transmit and receive web content, such as location-based content, according to a protocol, such as Wireless Application Protocol (WAP), hypertext transfer protocol (HTTP), and/or the like. The mobile user terminal 10 may be capable of using a Transmission Control Protocol/Internet Protocol (TCP/IP) to transmit and receive web content across the internet or other networks.

The mobile user terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. In addition, the processor 20 may further comprise user interface circuitry configured to control at least some functions of one or more elements of the user interface, such as a media recorder 29 configured to capture media content. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile user terminal may comprise a battery for powering various circuits related to the mobile user terminal, for example, a circuit to provide mechanical vibration as a detectable output. The display 28 of the mobile user terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display. The user input interface may comprise devices allowing the mobile user terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile user terminal.

The mobile user terminal 10 may comprise memory, such as a user identity module (UIM) 38, a removable user identity module (R-UIM), and/or the like, which may store information elements related to a mobile subscriber. In addition to the UIM, the mobile user terminal may comprise other removable and/or fixed memory. The mobile user terminal 10 may include non-transitory volatile memory 40 and/or non-transitory, non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile user terminal for performing functions of the mobile user terminal. For example, the memories may comprise an identifier, such as an international mobile equipment identification (IMEI) code, capable of uniquely identifying the mobile user terminal 10.

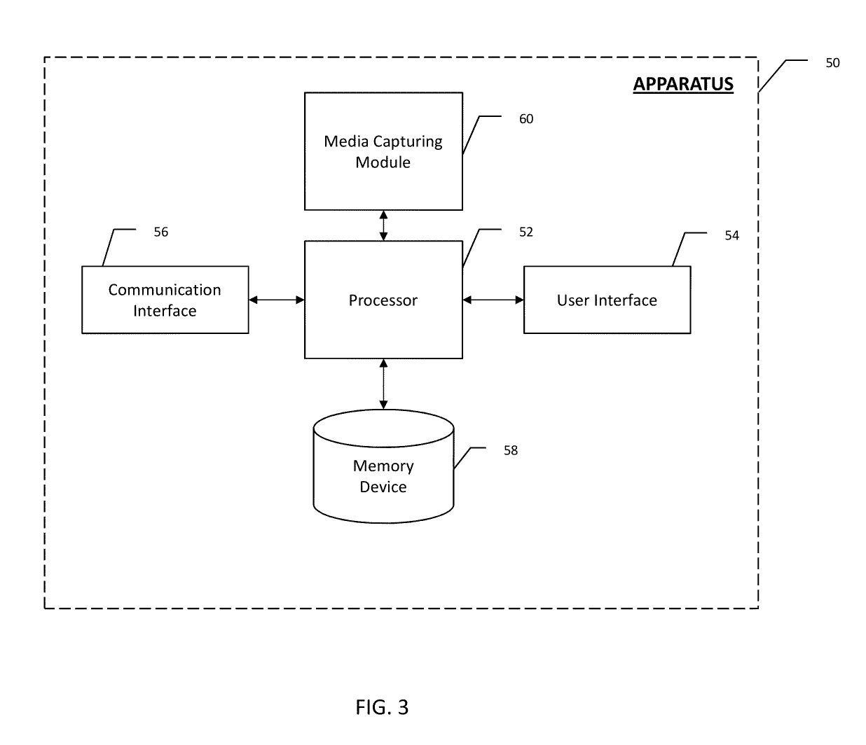

In an example embodiment, an apparatus 50 is provided that may be employed by devices performing example embodiments of the present invention. The apparatus 50 may be embodied, for example, as any device hosting, including, controlling, comprising, or otherwise forming a portion of the user terminal 10 and/or the media storage and alignment server 35. However, embodiments may also be embodied on a plurality of other devices such as for example where instances of the apparatus 50 may be embodied by a network entity. As such, the apparatus 50 of FIG. 3 is merely an example and may include more, or in some cases less, than the components shown in FIG. 3.

With further regard to FIG. 3, the apparatus 50 may be configured to capture media content via a media capturing module 60, such as a camera, a video camera, a microphone, and/or any other device configured to capture media content, such as pictures, audio recordings, video recordings and/or the like. The apparatus 50 may include or otherwise be in communication with a processor 52, an optional user interface 54, a communication interface 56 and a non-transitory memory device 58. The memory device 58 may be configured to store information, data, files, applications, instructions and/or the like. For example, the memory device 58 could be configured to buffer input data for processing by the processor 52. Alternatively or additionally, the memory device 58 could be configured to store instructions for execution by the processor 52.

As mentioned above, in some embodiments, the apparatus 50 may be embodied by a user terminal 10, the media storage and alignment server 35, or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 52 may be embodied in a number of different ways. For example, the processor 52 may be embodied as one or more of various hardware processing means such as a co-processor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. As such, in some embodiments, the processor 52 may include one or more processing cores configured to perform independently. A multi-core processor may enable multiprocessing within a single physical package. Additionally or alternatively, the processor 52 may include one or more processors configured in tandem via the bus to enable independent execution of instructions, pipelining and/or multithreading.

In an example embodiment, the processor 52 may be configured to execute instructions stored in the memory device 58 or otherwise accessible to the processor. The processor 52 may also be further configured to execute hard coded functionality. As such, whether configured by hardware or software methods, or by a combination thereof, the processor 52 may represent an entity (for example, physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor to perform the algorithms and/or operations described herein when the instructions are executed. However, in some cases, the processor 52 may be a processor of a specific device (for example, a user terminal, a network device such as a server, a mobile terminal, or other computing device) adapted for employing embodiments of the present invention by further configuration of the processor by instructions for performing the algorithms and/or operations described herein. The processor 52 may include, among other things, a clock, an arithmetic logic unit (ALU) and logic gates configured to support operation of the processor.

Meanwhile, the communication interface 54 may be any means such as a device or circuitry embodied in either hardware, software, or a combination of hardware and software that is configured to receive and/or transmit data from/to a network and/or any other device or module in communication with the apparatus 50. In this regard, the communication interface 54 may include, for example, an antenna (or multiple antennas) and supporting hardware and/or software for enabling communications with a wireless communication network (for example, network 30). In fixed environments, the communication interface 54 may alternatively or also support wired communication. As such, the communication interface 54 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 54 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further be configured to transmit and/or receive media content, such as a picture, video, and/or audio recording. In one embodiment, the communication interface 56 may be configured to transmit and/or receive a media content package comprising a plurality of data, such as a plurality of pictures, videos, audio recordings and/or any combination thereof. In this regard, the processor 52, in conjunction with the communication interface 56, may be configured to transmit and/or receive a media content package relating to media content captured at a particular event, location, and/or time. Accordingly, the processor 52 may cause the media content package to be displayed upon a user interface 54, such as a display and/or a touchscreen display. In this regard, the media content package may be displayed as a series of pictures and/or videos that have been properly aligned and time-stamped along a singular timeline, irrespective of the device that original captured the media content.

Although the apparatus 50 need not include a user interface 54, such as in instances in which the apparatus is embodied by the media storage and alignment server 35, the apparatus of other embodiments, such as those in which the apparatus is embodied by a user terminal 10, may include a user interface. In those embodiments, the user interface 54 may be in communication with the processor 52 to receive an indication of a user input at the user interface 54 and/or to provide an audible, visual, mechanical or other output to the user. As such, the user interface 54 may include, for example, a keyboard, a mouse, a joystick, a display, a touch screen, a microphone, a speaker, or other input/output mechanisms. Alternatively or additionally, the processor 52 may comprise user interface circuitry configured to control at least some functions of one or more elements of the user interface 54, such as, for example, the speaker, the ringer, the microphone, the display, and/or the like. The processor 52 and/or user interface circuitry comprising the processor 52 may be configured to control one or more functions of one or more elements of the user interface 54 through computer program instructions (e.g., software and/or firmware) stored on a memory accessible to the processor 52 (e.g., memory device 58, and/or the like). In another embodiment, the user interface 54 may be configured to record and/or capture media content as directed by a user. Accordingly, the apparatus 50, such as the processor 52 and/or the user interface 54, may be configured to capture media content with a camera, a video camera, and/or any other image data capturing device and/or the like.

In one embodiment, the media content that is captured may include a device-specific timestamp that provides a unique identifier as to when the media content was captured relative to other media content captured by the same device. In this regard, the apparatus 50 may include a processor 52, user interface 54, and/or media capturing module 60 configured to provide a timestamp associated with media content captured by the apparatus 50. The processor 52 may include, among other things, a clock to support the operation of time-stamping the media content captured by the apparatus 50. According to some embodiments, a captured media content may further include data corresponding to a device identifier. As such, a media content captured by the first device will include data indicating that the picture, video recording, audio recording and/or the like was captured by the first device. Additionally and/or alternatively, the captured media content may further include data corresponding to recording time information. For example, in some embodiments, the captured media content may include data indicating that a particular picture was captured at 9:35 PM according to a timestamp associated with the media content captured by the first device. In some instances, the apparatus may be configured to provide a timestamp different from the actual time. The apparatus, however, may include a processor 52, a user interface 54, and/or media capturing module 60 configured to measure, capture, and/or record time intervals corresponding to when each particular media content was captured by the apparatus. Accordingly, a first media content captured by the first device may include multiple pictures and/or videos that include recording time information accurate with respect to each of the pictures and/or videos captured by the first device.

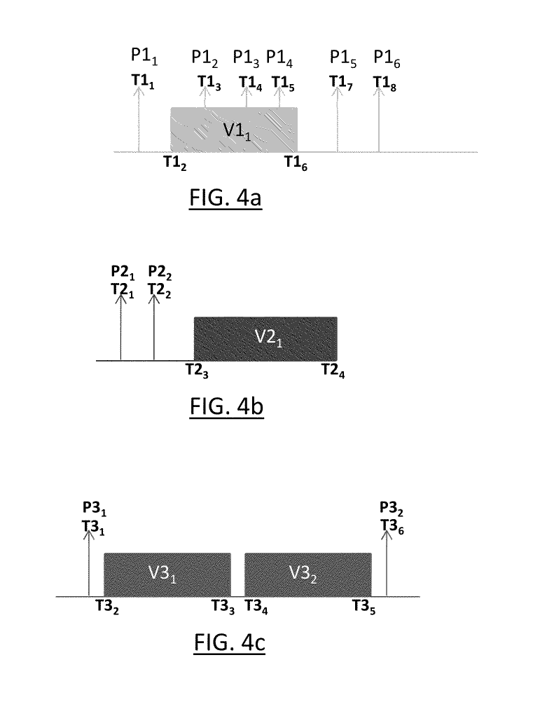

In terms of methods associated with embodiments of the present invention, the above-described apparatus 50 or other embodiments of apparatuses may be employed. In this regard, FIGS. 4a, 4b, and 4c each illustrate a timeline of media content captured specific to the respective devices that captured the media content. As shown in FIG. 4a, the first device captured media content comprising six pictures and a single video. The first picture, P1₁, was captured at a first time, T1₁, which is specific to the first device. As illustrated in FIG. 4a, the first device also captured a video file, V1₁ that began at a time, T1₁, and ended at a later time, T1₆. Each of the media content captured by the first device includes a specific time stamp marker associated with the media content captured. Accordingly, each picture includes a respective time stamp and each video consists of a time start stamp and a time end stamp detailing the start and stop times of the video data.

Likewise, FIG. 4b illustrates a timeline of media content captured by a second device according to embodiments of the present invention. As shown in the figure, the second device captured media content comprising one video file and two pictures. The video file V2₁ includes a respective time start stamp T2₃ and a time stop stamp T2₄. Further, the second device captured two pictures, each having a respective timestamp indicating when the particular picture was captured. Unlike the first timeline for the first device, as shown in FIG. 4a, the second timeline for the media captured by the second device may or may not be synchronized with the first timeline and/or any other timeline for any other respective device. More specifically, the second timeline may show that a picture was taken at 10:00 PM EST, and the device may be configured to stamp the picture with a time stamp T2₁ that indicates the picture was taken at 10:00 PM EST. However, the second device may be configured by a user to display and/or use a time different from the actual accurate time. For instance, a user may wish to set a device to illustrate a time that is 5 minutes faster than the actual time. Accordingly, in such a case, the second device may illustrate the picture was taken at 10:00 PM EST when in fact, the picture was actually taken at 9:55 PM EST. Embodiments of the present invention, however, provide for accurate time alignment of media content captured by multiple devices irrespective of any inaccuracies between the actual time and the time as indicated by respective devices.

In addition, FIG. 4c illustrates another timeline of media content captured by a third and different device. The third device captured media content comprising two video files and two pictures. Like the first and second devices, the third device may be configured to provide a timestamp for each picture taken and a time start stamp and a time end stamp for each of the video files captured. As such, the third device includes a first video V3₁ and a second video V3₂. The first video V3₁ includes a time start stamp T3₂ and a time end stamp T3₃. In addition, the second video V3₂ includes a time start stamp T3₄ and a time end stamp T3₅.

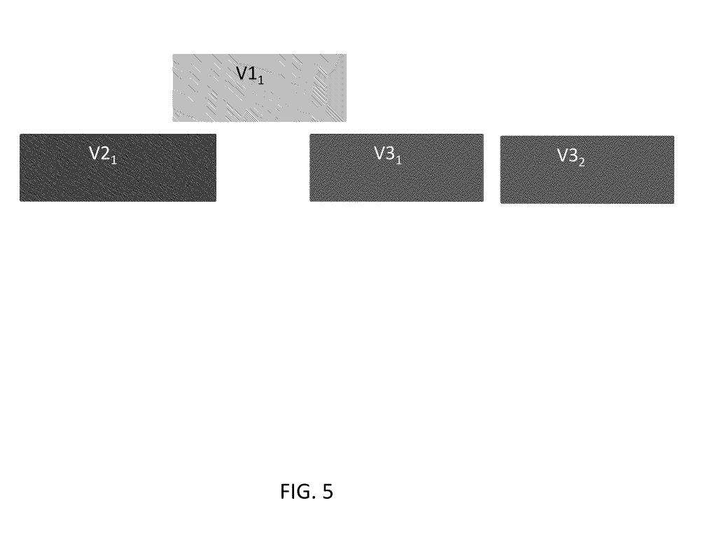

Embodiments of the present invention provide for aligning the media content captured by a number of different devices at a particular event. The media content captured by different devices and aligned according to embodiments of the present invention may include picture data, video data, audio data, and/or the like. Accordingly, FIG. 5 illustrates the alignment of certain media content captured by different devices along a singular unified timeline. Specifically, FIG. 5 illustrates that the video files from each of the first, second, and third devices, as shown in FIGS. 4a-4c respectively, are aligned along a single timeline. According to embodiments of the present invention, each of the devices may be configured to capture media content and provide and/or transmit the media content with a unique device recorder identifier that is associated with the media content. Accordingly, each of the media content that is provided by a single device will include the same unique device recorder identifier for the respective device.

Further, as shown in FIG. 5, embodiments of the present invention provide for the alignment of continuous media, such as audio or video files, taken from different devices. Continuous media from a first device may be aligned with respect to other continuous media from other devices based upon audio or video-scene similarities and may be aligned along a relative time-scale that is independent from any of the timelines for the devices. For example, an audio recording from a first device may be matched to another audio recording from a second device based at least in part on the similar sound waves of the two audio recordings. Alternatively and/or additionally, a video recording from a first device may be matched to a video recording of a second device based at least in part on the similar audio portions of the first and second video recordings and/or based at least in part on similar scenes between the first and second video recordings. For example, scenes from a first video recording captured by a first device may be matched and/or aligned to scenes from a second video recording captured by a second device even when the two video recordings are captured from different angles. As an example, a first video recording captured by a first device of a particular event may include scenes where flashes from picture cameras are captured. Even though a second video recording captured by a second device may be taken from a different angle, the time intervals between the flashes from the picture cameras may be aligned so as to coincide with the time intervals between the flashes from the picture cameras as captured in the first video recording. As such, the scenes from a plurality of video recordings from a plurality of devices may be aligned based at least in part on scene similarities and/or audio recording similarities. Accordingly, embodiments of the present invention may provide for alignment of all continuous media recorded by different users on different devices at the same event. As such, FIG. 5 illustrates the alignment of the four video files captured by the three different devices along a relative time scale by calculating the time-offset between the start times of each of the video clips.

In some embodiments, a first video recording captured by a first device may not include video and/or audio portions that match, align, and/or overlap with video and/or audio portions from a second video recording captured by a second device. In such an instance where a first video recording and a second video recording do not include overlapping portions, non-continuous media content captured by a first device, such as pictures, may be temporally aligned with continuous media content, such as video recordings and/or audio recordings, which have been captured by the same first device.

According to some embodiments, a media storage and alignment server may be configured to receive a plurality of continuous media content. Additionally and/or alternatively, the media storage and alignment server may be further configured to align the plurality of continuous media content. In some embodiments, the media storage and alignment server may align some of the continuous media content with other continuous media content, and may fail to align other continuous media content with the aligned media content. For example, a first and second continuous media content, which may be captured by a first and second device respectively, may contain portions of media content that match, align, and/or overlap with one another, while a third continuous media content, which may be captured by a third device, contains no portions of media content that match, align, and/or overlap with either the first or second media content. Accordingly, the first and second continuous media content may be aligned with one another, while the third continuous media content is not aligned with either the first or second continuous media content. In such an instance in which some of the plurality of continuous media contents are aligned with one another while other continuous media content remains unaligned, a media storage and alignment server may be configured to align non-continuous media content that may have been captured by a device that captured continuous media content that has been aligned with other continuous media content. For example, a first device may have captured a first continuous media content and a plurality of non-continuous media content, a second device may have captured a second continuous media content and a plurality of non-continuous media content, and a third device may have captured a third continuous media content and a plurality of non-continuous media content. Additionally and/or alternatively, the first continuous media content and the second continuous media content may have portions that match, align, and/or overlap, while the third continuous media content contains no portions that match, align, and/or overlap with either the first continuous media content or the second continuous media content. As such, in some embodiments, the plurality of non-continuous media content captured by the first and second device respectively may be temporally aligned with respect to one another while the non-continuous media content captured by the third device is not aligned with the media content.

In some embodiments, a first device may have captured a first continuous media content and a plurality of non-continuous media content, a second device may have captured a second continuous media content and a plurality of non-continuous media content, and a third device may have captured a third and fourth continuous media content and a plurality of non-continuous media content. The first continuous media content and the second continuous media content may contain portions that match, align, and/or overlap with one another, while the third and fourth continuous media content, which was captured by the third device, do not include any portions that match, align, and/or overlap with either the first or second media content. Additionally and/or alternatively, a temporal gap may exist between the ending of the third continuous media content and the beginning of the fourth continuous media content. In addition to capturing the third and fourth continuous media content, the third device may also have captured a plurality of non-continuous media content. Although a temporal gap exists between the third and fourth continuous media content, the non-continuous media content captured by the third device may be aligned with respect to the third continuous media content, the temporal gap, and/or the fourth continuous media content as the plurality of non-continuous media content and the third and fourth continuous media content were all captured by the same device.

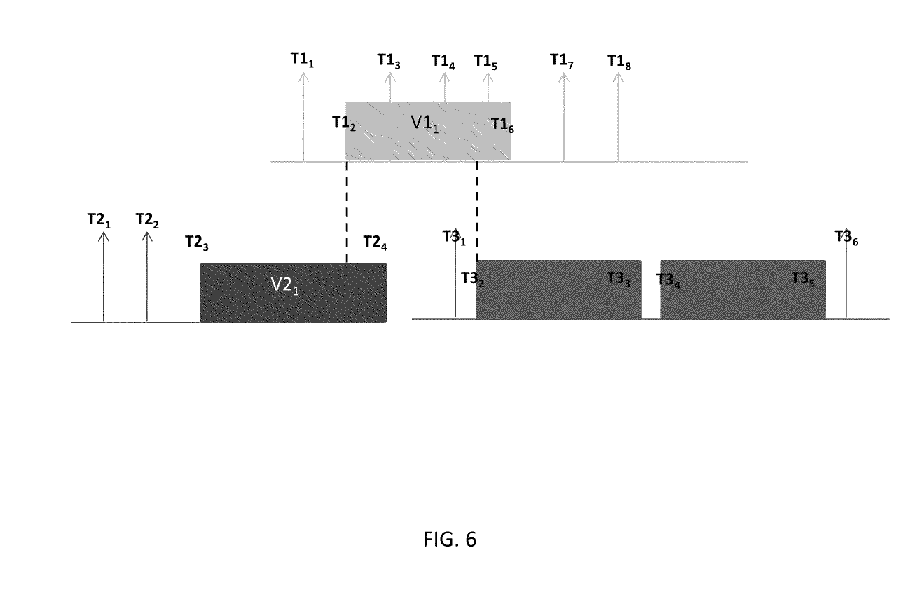

As such, this alignment of the continuous media provides for the alignment of all media captured by any number of devices at a particular event. FIG. 6 illustrates the alignment of each of the respective device timelines to a single temporally aligned timeline independent of the device timeline. As the continuous media files have already been aligned with one another based in part on the continuous media time start stamp, each of the timestamps from each of the respective devices may be aligned to the single temporally aligned timeline that is independent from the respective device timelines. Specifically, because a second measured by any one of the device timelines is equal to a second as measured by the single temporally aligned timeline, a timestamp from a first picture on the first timeline that precedes the time start stamp of the video file by a number of seconds on the first timeline will also precede the time start stamp of the video file that is temporally aligned along the relative time scale of the single temporally aligned timeline by an equal number of seconds. Accordingly, FIG. 6 illustrates the respective timestamps for each of the three devices aligned along the relative timescale.

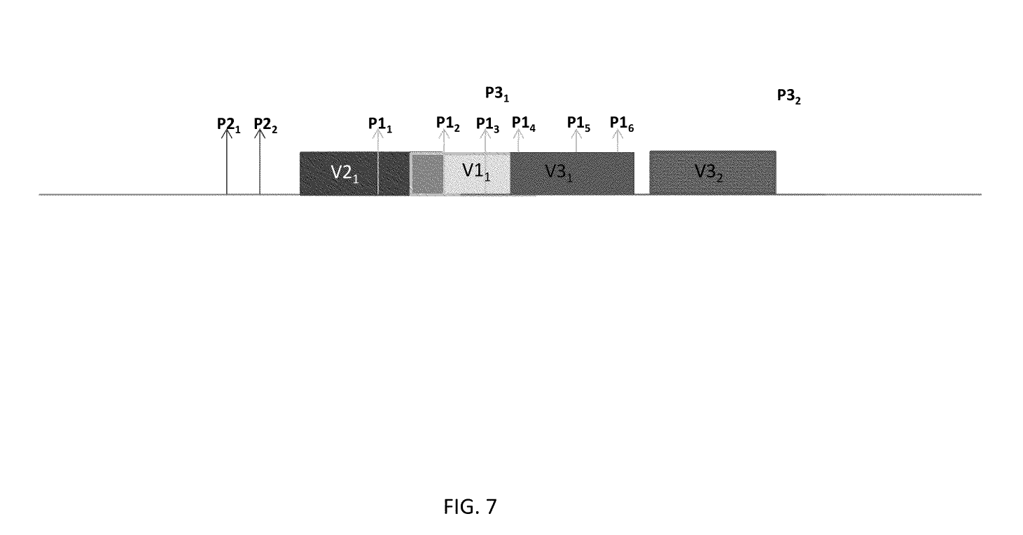

Once the time stamps for each of the media content captured by the respective devices are aligned along the relative timescale, the media content associated with the now aligned time stamps may be temporally aligned with one another, as shown in FIG. 7. Thus, each of the media content captured by the numerous devices is temporally aligned along a single timeline. Accordingly, one may now access media content captured from different users recorded by different devices at a particular event along a single timeline, wherein each of the media content is aligned with respect to one another. As such, embodiments of the present invention may further provide for generation of chronological slide shows of media content captured by different devices, insertion of relevant pictures in an automatic video remix, and/or media indexing or media searching capabilities.

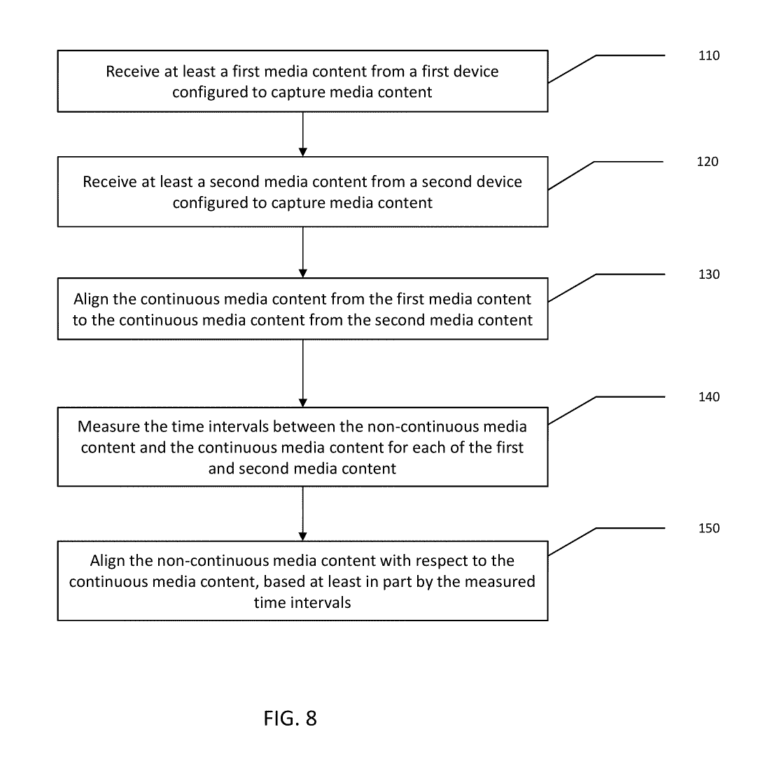

FIG. 8 is a flowchart of a system, method and program product according to example embodiments of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include receiving captured media content from a first device at operation 110. In this regard, the apparatus 50 may include means, such as the communication interface 56, the processor 52, the media capturing module 60 or the like for receiving the captured the media content. Further, the method may include receiving captured media content from a second device at operation 120. Additionally, the method may include receiving a unique device recorder identifier for each of the media content captured by a particular device. The apparatus 50 may therefore also include means, such as the memory device 58, the processor 52, the communication interface 56 or the like, for receiving the captured media content from a second device and for receiving the unique device recorder identifier. Additionally, the method may include aligning continuous media content provided by the respective devices at operation 130. As such, the apparatus 50 may include means, such as the processor 52, memory device 58, or the like, for aligning the continuous media content. Media content from a first device may be aligned by comparing similarities between continuous media content from the first device to the continuous media content of a second device. For example, a portion of an audio recording from the first device may be matched and/or aligned to at least a portion of an audio component of a video recording from a second device. Any combination of continuous media content from a first device may be matched and/or aligned with the continuous media content from a second device. With reference to FIG. 6, a first portion of a first video file V1₁ starting at time T1₁ captured from a first device may overlap an end portion of a first video file starting at time T2₃ and ending at time T2₄ captured by the second device. Accordingly, the continuous media content of the two separate video files may be aligned along a singular temporally aligned timeline based at least in part on the overlapping similarities between the two continuous media content.

In addition, the method may include measuring the time intervals between the continuous and non-continuous or static media content provided by each of the respective devices at operation 140. For example, referring to FIGS. 4a, 4b, 4c, and 6, each of the respective first, second and third devices may include non-continuous media having a timestamp associated with each of the non-continuous media. As shown in FIG. 6, a first device may include a first picture taken at time T1₁ and a video file having a start time of T1₂. Accordingly, the method may include measuring the time interval between T1₁ and T1₂. Because the number of seconds between T1₁ and T1₂ as measured by the first device timeline is equal to the number of seconds on any of the other timelines, including the singular temporally aligned timeline, the method may provide for the alignment of non-continuous media based at least in part on the measured time intervals. Further, the method may include aligning static or non-continuous media content provided by each of the respective devices at operation 150. As such, the apparatus 50 may include means, such as the processor 52, memory device 58, or the like, for measuring the time intervals and for aligning the static media content.

In some embodiments, the measurement of time intervals and the alignment of media content may be performed by an apparatus that captures the media content itself, such as a mobile user terminal, in which receipt of captured media content from a device may be receipt of captured media by the media capturing module 60. In other embodiments, the measurement of time intervals and the alignment of media content may be performed by an apparatus that does not capture any media content itself, but receives media content captured by other devices, such as mobile terminals. One such example apparatus that may be configured to align the media content, but that does not capture media content itself may include a media storage and alignment server 35.

In some embodiments, certain operations may be further modified or additional operations may be included for aligning media content captured by varying devices at a particular event. In one embodiment, the method may include receiving media content having a unique device timestamp, as the device time stamp may not correlate to the single temporally aligned timeline and the relative timestamp provided by a media storage and alignment server.

Some advantages of embodiments of the present invention may include the alignment of non-continuous media of an event captured by multiple devices without any additional complex computations from aligning continuous media captured by those multiple devices. Further advantages may include the accurate temporal alignment of non-continuous media, such as images and/or pictures, without requiring a previous synchronization of the multiple devices that are configured to capture the non-continuous media.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
receive at least a first media content from a first device configured to capture media content;
receive at least a second media content from a second device configured to capture media content, wherein the first and second media content each comprise at least one continuous media content, and wherein at least one of the media content comprises a non-continuous media content;
align the continuous media content from the first media content to the continuous media content from the second media content;
measure the time intervals between the non-continuous media content and the continuous media content for any media content captured by a device, wherein the media content comprises non-continuous media content and continuous media content; and
align the non-continuous media content with respect to media content captured by another device, based at least in part by the measured time intervals.

2. The apparatus of claim 1 further configured to receive a unique device recorder identifier corresponding to each of the plurality of devices.

3. The apparatus of claim 1 further configured to receive data corresponding to recording time information of a media content.

4. The apparatus of claim 1 further configured to align the continuous media content from a plurality of devices based at least in part on audio or video data similarities of the continuous media content from each of the respective devices.

5. The apparatus of claim 1 further configured to align the time intervals measured between the continuous and non-continuous media content with a single unified timeline.

6. The apparatus of claim 1 further configured to display the received media content along a single relative timeline.

7. A method, comprising:
receiving at least a first media content from a first device configured to capture media content;
receiving at least a second media content from a second device configured to capture media content, wherein the first and second media content each comprise at least one continuous media content, and wherein at least one of the media content comprises a non-continuous media content;
aligning, by a processor, the continuous media content from the first media content to the continuous media content from the second media content;
measuring the time intervals between the non-continuous media content and the continuous media content for any media content captured by a device, wherein the media content comprises non-continuous media content and continuous media content; and
aligning the non-continuous media content with respect to the continuous media content, based at least in part by the measured time intervals.

8. The method of claim 7 further comprising receiving a unique device recorder identifier corresponding to each of the plurality of devices.

9. The method of claim 7 further comprising receiving data corresponding to recording time information of a media content.

10. The method of claim 7 further comprising aligning the continuous media content from a plurality of devices based at least in part on audio or video data similarities of the continuous media content from each of the respective devices.

11. The method of claim 7 further comprising aligning the time intervals measured between the continuous and non-continuous media content with a single unified timeline.

12. The method of claim 7 further comprising displaying the received media content along a single relative timeline.

13. A computer program product comprising at least one non-transitory computer-readable storage medium having computer-readable program instructions stored therein, the computer-readable program instructions comprising program instructions configured to cause an apparatus to perform a method comprising:
receiving at least a first media content from a first device configured to capture media content;
receiving at least a second media content from a second device configured to capture media content, wherein the first and second media content each comprise at least one continuous media content, and wherein at least one of the media content comprises a non-continuous media content;
aligning the continuous media content from the first media content to the continuous media content from the second media content;
measuring the time intervals between the non-continuous media content and the continuous media content for any media content captured by a device, wherein the media content comprises non-continuous media content and continuous media content; and
aligning the non-continuous media content with respect to the continuous media content, based at least in part by the measured time intervals.

14. The computer program product of claim 13 further configured to cause an apparatus to perform a method further comprising receiving a unique device recorder identifier corresponding to each of the plurality of devices.

15. The computer program product of claim 13 further configured to cause an apparatus to perform a method further comprising receiving data corresponding to recording time information of a media content.

16. The computer program product of claim 13 further configured to cause an apparatus to perform a method further comprising aligning the continuous media content from a plurality of devices based at least in part on audio or video data similarities of the continuous media content from each of the respective devices.

17. The computer program product of claim 13 further configured to cause an apparatus to perform a method further comprising aligning the time intervals measured between the continuous and non-continuous media content with a single unified timeline.

18. The computer program product of claim 13 further configured to cause an apparatus to perform a method further comprising displaying the received media content along a single relative timeline.
